(19) United States
(12) Patent Application Publication
(10) Pub. No.: US 2023/0069074 A1
(43) Pub. Date: Mar. 2, 2023

(54) INTERDEPENDENT CAUSAL NETWORKS FOR ROOT CAUSE LOCALIZATION

(71) Applicant: NEC Laboratories America, Inc., Princeton, NJ (US)

(72) Inventors: Zhengzhang Chen, Princeton Junction, NJ (US); Haifeng Chen, West Windsor, NJ (US); Jingchao Ni, Princeton, NJ (US); Zheng Wang, Salt Lake City, UT (US); Liang Tong, Lawrenceville, NJ (US)

(21) Appl. No.: 17/888,819

(22) Filed: Aug. 16, 2022

Related U.S. Application Data
(60) Provisional application No. 63/235,205, filed on Aug. 20, 2021.

(51) Int. Cl. G06N 3/08; G06F 11/34

(52) U.S. Cl. CPC G06N 3/08; G06F 11/3409

(57) ABSTRACT

A method is provided for training a hierarchical graph neural network. The method includes using a time series generated by each of a plurality of nodes to train a graph neural network to generate a causal graph, and identifying interdependent causal networks that depict hierarchical causal links from low-level nodes to high-level nodes to the system key performance indicator (KPI). The method further includes simulating causal relations between entities by aggregating embeddings from neighbors in each layer, and generating output embeddings for entity metrics prediction and between-level aggregation.

### RELATED APPLICATION INFORMATION

This application claims priority to U.S. Provisional; Application No. 63/235,205, filed on Aug. 20, 2021, incorporated herein by reference in its entirety.

### BACKGROUND

### Technical Field

The present invention relates to neural networks for root cause analysis, and more particularly hierarchical graph neural networks trained for causal discovery.

### Description of the Related Art

Root cause analysis (RCA) is a systematic process for analyzing problems or events to identify, what happened, how it happened, and why it happened. Root cause analysis (RCA) can identify the source of system problems using monitoring system metrics, and help maintaining the stability and robustness of large-scale complex systems. RCA may establish a sequence of events for understanding the relationships between causal factors and the problem under investigation. An analysis method, for example, an Ishikawa Diagram or Fish-Bone Diagram may provide a systematic way of looking at effects and the causes that create or contribute to a problem. Failure Modes and Effects Analysis (FMEA) may identify various modes of failure within a system or process.

In complex systems, failures and malfunctions are inevitable. When a system failure happens, manually diagnosing/localizing the root cause is time-consuming, labor-intensive, and error prone. Root cause analysis (RCA) can systematically identify “root causes” of problems or events and respond to them. RCA also helps to avoid treating symptoms rather than true, underlying causes that contribute to a problem or event.

Existing methods can mainly focus on identifying the root causes on a single isolated network, while many real-world systems are complex and exhibit interdependent structures (i.e., multiple networks of a system are interconnected by cross-network links). Existing methods also may only consider physical or statistical correlations, but not causation, and thus cannot be directly applied for locating root causes.

A system key performance indicator (KPI) or system status indicator (SSI) is a monitoring time series that indicates the system status. KPI is a quantifiable measure of performance over time for a specific objective, for example, up-time and mean-time between failures (MTBF).

Microservices architecture refers to an architectural style for developing applications. Microservices allow a large application to be separated into smaller independent parts, with each part having its own realm of responsibility. To serve a single user request, a microservices-based application can call on many internal microservices to compose its response. Each microservice can be built around a business capability, and runs in its own process. It can communicate with the other microservices in an application through lightweight mechanisms (e.g., HTTP APIs).

### SUMMARY

According to an aspect of the present invention, a method is provided for training a hierarchical graph neural network. The method includes using a time series generated by each of a plurality of nodes to train a graph neural network to generate a causal graph, and identifying interdependent causal networks that depict hierarchical causal links from low-level nodes to high-level nodes to the system key performance indicator (KPI). The method further includes simulating causal relations between entities by aggregating embeddings from neighbors in each layer, and generating output embeddings for entity metrics prediction and between-level aggregation.

According to another aspect of the present invention, a method is provided for identifying most probable root causes. The method includes detecting a system failure, and conducting topological cause learning by extracting causal relations from entity metrics data and system key performance indicator (KPI) data. The method further includes propagating the system failure over a learned causal graph, and generating a topological cause score representing how much a component can be the root cause. The method further includes generating an individual cause score based on entity metrics using extreme value theory, and detecting anomalous entities based on performance of individual components. The method further includes aggregating the topological cause score and individual cause score to obtain a root cause ranking to discover the most probable root causes, and identifying a top K system entities associated with the most probable root causes.

According to yet another aspect of the present invention, a system is provided for identifying most probable root causes. The system includes one or more processors, a display screen coupled to the one or more processors through a bus, and a memory coupled to the one or more processors through the bus, wherein the memory includes a topological causal discover tool configured to system key performance indicator (KPI), detect a system failure, conducting topological cause learning by extracting causal relations from entity metrics data and system key performance indicator (KPI) data, propagate the system failure over a learned causal graph, and generate a topological cause score representing how much a component can be the root cause; an individual causal discovery tool configured to receive entity metrics, generate an individual cause score based on the entity metrics using extreme value theory, and detect anomalous entities based on performance of individual components; and an integration tool configured to aggregate the topological causal score and the individual causal score to obtain a root cause ranking to discover the most probable root causes, identify a top K system entities associated with the most probable root causes, wherein identifying most probable root causes does not require any domain/prior knowledge as input for root cause localization, and display the most probable root causes to a user on the display screen.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a cascading failure between interacting systems in interdependent causal networks that would generate a root cause analysis, in accordance with an embodiment of the present invention;

FIG. 2 is a block/flow diagram illustrating a system/method for a neural network framework for topological causal discovery, in accordance with an embodiment of the present invention;

FIG. 3 is a flow diagram illustrating a system/method for an extreme value theory framework for individual causal discovery, in accordance with an embodiment of the present invention, in accordance with an embodiment of the present invention;

FIG. 4 is a flow diagram illustrating a system/method for an interdependent causal network framework for causal integration, in accordance with an embodiment of the present invention; and

FIG. 5 is a block diagram illustrating a system for a neural network framework for topological causal discovery and individual causal discovery, in accordance with an embodiment of the present invention.

### DETAILED DESCRIPTION OF PREFERRED EMBODIMENTS

In accordance with embodiments of the present invention, systems and methods are provided for a generic root cause localization framework that can be applied in real scenarios without massive domain knowledge. Web-based services have many components running in the large-scale infrastructure with complex interactions. These large-scale, often distributed, systems can have different levels of components that work together in a highly complex and coordinated manner. These networks can interact with each other, and the failure of a system entity in one network could spread to the dependent entities in other networks, which in turn may result in cascading damages that could circulate through the interconnected levels with catastrophic consequences. In a microservice system, for example, the lower level can be the level of physical pods running microservices, the higher level can be the level of network servers containing such pods, and the system level represents the performance of the whole group of servers. An effective root cause localization algorithm for real complex systems can identify root cause components through automatically learning interdependent causal relations between different levels of system components and the system status indicator.

There are numerous complicated real-world systems that play crucial roles in maintaining the normal functioning of civilization. To maintain the reliability and robustness of such systems, the system's key performance indicator (KPI) and metrics can be monitored in real time. However, due to the vast quantity of monitoring data and the complexity of such systems, identifying root causes is time-consuming, labor-intensive, and needs extensive domain expertise. Domain knowledge, however, may be lacking for many complex systems, thereby making identifying root causes impractical or even impossible. The root causes of system failures for these large and distributed systems may be identify by automatically analyzing the vast amounts of monitoring data.

Almost all real-world critical infrastructures interact with one another. This has led to an emerging new field in network science that focuses on what are called interdependent networks. In these systems, networks interact with one another and exhibit structural and dynamical features that differ from those observed in isolated networks. In interdependent networks the failure of a node in one network leads to the failure of the dependent nodes in other networks, which in turn may cause further damage to the first network, leading to cascading failures and possible catastrophic consequences. One example of a cascading failure is the electrical blackout that affected much of Italy in 2003 caused by a breakdown in two interdependent systems: the communication network and the power grid. In interdependent networks, the malfunctioning patterns of problematic system entities can propagate across different networks or different levels of system entities. Thus, ignoring the interdependency can result in suboptimal root cause analysis results.

In various embodiments, a score-based causal graph learning method can be created by building hierarchical graph neural networks to enable more robust, more scalable, and faster structure learning. A causal graph can be built by learning the structure of a GNN. By sharing parameters between graph nodes, the number of parameters does not increase rapidly as the system scales. With GNNs as basic building blocks, a hierarchical GNN can be applied to incorporate complex hierarchical structures of the data. Thus, the interactions between different levels can be taken into consideration.

The goal of hierarchical causal graph learning is to extract causal relations from entity metrics data, system KPI data, and the inherent data structure. Hierarchical graph structures may be utilized in identifying root causes in large-scale complex systems that may have different levels of system entities. Causal links may be automatically assessed between monitoring system metrics and system KPI using a generic framework. In various embodiments, the framework includes two branches: 1) individual causal discovery, and 2) topological causal discovery. For the individual causal discovery, the temporal pattern of the system metric of nodes (e.g., system components) may be analyzed in isolation. A time series can be generated by each node, which can be used to train a graph neural network to generate a causal graph. This can be an unsupervised and on-going process in contrast to a dedicated training period. For the topological causal discovery, interdependent causal networks that depict hierarchical causal links from low-level nodes to high-level nodes to the system key performance indicator (KPI) may be identified. Interdependent networks, also called a network of networks (NoN), can model the complex interconnections among different networks.

In a non-limiting exemplary embodiment, a KPI can be, for example, latency or connection time. The lower the latency is, the better the system is performing. If the latency time is infinite, that can indicate the system has failed.

When a system failure happens, it firstly conducts topological cause learning by extracting causal relations from entity metrics data, e.g., CPU utilization, memory usage, and system key performance indicator (KPI) data, e.g., response latency, and propagating the system failure over the learned causal graph. Consequently, a topological cause score representing how much a component can be the root cause will be obtained. Secondly, it applies an individual cause learning via the extreme value theory to detect anomalous entities, where it looks at the performance of individual components. Individual cause learning detects individual cause of the entity metrics via the extreme value theory and assign individual cause score accordingly, where a higher score means behavior is more anomalous. It helps to detect the root cause because the root cause often gets anomalous before the system failure. By aggregating the results from topological cause learning and individual cause learning, a root cause ranking is obtained to discover most probable root causes, as well as a causal graph serving as a system knowledge graph for system insights. Combining the topological causal score(s) and individual causal score(s), root causes can be identified as the top K system entities.

In one or more embodiments, an attention-based graph neural network may be trained to detect correlations among sensors and utilized attention scores to identify root causes. A graph data model may be used to capture complex topological causal relations in real-world systems for localizing root causes.

Vector autoregression is a statistical model used to capture the relationship between multiple quantities as they change over time. VAR (vector autoregressive models) models can be used for multivariate time series. Historical time series data can be collected by monitoring the system components, such as CPU usage, network traffic statistics, and sometimes sensory measurements in physical systems.

Cloud computing facilities with a microservice architecture can have of hundreds of different levels of components that vary from machines/containers to application software/pods. A microservice system can have hundreds of thousands of microservice instances residing in a large number of servers. Multiple anomalous microservices can be observed during one system failure. It is not only the number of variables that hinders discovering the root cause but also the complex hierarchical structure of the system and the extremely dynamic interactions between microservices and servers.

Historical time series data can be collected by monitoring these system components, such as CPU usage, network traffic statistics, and sometimes sensory measurements in physical systems. Agents can collect the microservice data by employing the open-source JMeter and Openshift/Prometheus. Two types of monitored data can be used in the root cause analysis engine: the JMeter report data of the whole system and the metrics data of the running containers/nodes and the applications/pods. The JMeter data can include the system performance KPI information, such as elapsed time, latency, connect time, thread name, throughput etc. This data can be in the following format, for example, timeStamp, elapsed, label, responseCode, responseMessage, threadName, dataType, success, failureMes sage, bytes, sentBytes, grpThreads, allThreads, URL, Latency, IdleTime, Connect_time.

Latency and Connect_time may be used as two performance KPIs of the whole microservice system, where the Latency measures the latency from just before sending the request to just after the first chunk of the response has been received, while Connect_time measures the time it took to establish the connection, including an SSL handshake. Both Latency and Connect_time can be supplied as time series data, which can indicate the system status and directly reflects the quality of service: whether the whole system have some failures events happened or not, because the system failure would result in the latency or connect time significantly increasing.

The metrics data, on the other hand, can include a number of metrics which indicates the status of a microservice's underlying component/entity. The underlying component/entity can be a microservice's underlying physical machine/container/virtual machine/pod. The corresponding metrics can be, for example, the CPU utilization/saturation, memory utilization/saturation, or disk IO utilization. All of these metrics data can also be time series data. An anomalous metric of a microservice's underlying component can be the potential root cause of an anomalous JMeter Latency/Connect_time, which indicates a microservice failure.

In various embodiments, the extreme value distribution of changing events in each system component's metric can be estimated. The individual causal score for each component can be calculated based on the learned distribution.

In various embodiments, interdependent causal relationships in multi-network systems can be learned for accurately locating root causes when a system failure/fault occurs.

In various embodiments, during the learning process, graph neural networks can learn more robust non-linear causal relations through the message passing mechanism. For inter-layer learning, low-level information can be combined into high-level nodes to influence the causal learning process at the high-level. Assuming that the negative impacts of root causes spread to neighboring nodes until system failure, a network propagation mechanism can be used to simulate the error propagation process in order to infer real root causes.

The message passing mechanism enhances non-linear causal relation learning among system entities. This block can be duplicated many times to learn more complex causation.

For example, payment processing and ordering can be separated as independent units of services, so payments continue to be accepted if invoicing is not working.

In various embodiments, a two-step root cause analysis (RCA) can be utilized, where a first step involves analysis of a topological cause, and a second step can involve analysis of an individual cause. Applying causal graph learning and network propagation can be used to analyze how different components of a system are affected by a root cause through interactions within the system for identifying a topological cause. An individual cause of the system metrics can be detected with the extreme value theory, where the root cause metrics may become anomalous at some time before failure.

During hierarchical causal graph learning, GNNs are treated as building blocks to construct the hierarchical structure. A GNN with L layers takes the input features or augmented input features from the previous adjacent level, simulates the causal relations between entities by aggregating embeddings from neighbors in each layer, and generates the output embeddings for entity metrics prediction and between-level aggregation. The number of layers, L, in GNN impacts the learning scenario of interdependent causal structures.

In each layer, embedding s are aggregated according to the adjacent matrix, and then fed to the next layer. With different adjacent matrix for each layer and directed acyclic graph (DAG) constraint enforcing a stronger sparsity, the GNN can capture the causal relations between entities more effectively while enable a faster learning process.

For network propagation, two causal graphs, i.e., a causal graph during normal system status and a causal graph during abnormal system status, are constructed. Vanishing edges between two causal graphs are identified by checking the difference of two adjacency matrices. A network propagation based on vanishing edges is applied to compute the topological cause score.

For the topological causal relation, we suppose that different system components are interrelated and the anomalous behaviors of system faults spreads through these connections. Network propagation is utilized to detect the real spread chain of system faults based on the learned graphs. This process outputs the topological causal score of each system component. Finally, we integrate the individual and topological causal score and rank all system components based on the integrated one. The top K components are considered to be the most possible root causes of system faults.

In various embodiments, an interdependent causal networks based framework can enable the automatic discovery of both intra-level (i.e., within-network) and inter-level (i.e., across network) causal relationships for root cause localization. The framework can include Topological Causal Discovery and Individual Causal Discovery, where the Topological Causal Discovery component aims to model the fault propagation for tracing back root causes, and the Individual Causal Discovery component focuses on individual causal effects, by analyzing each system entity's metric data (i.e., time series).

An underlying hypothesis is that the metric data of the root cause(s) often fluctuate more strongly than those of other system entities during the incidence of system faults/failures. The Individual Causal Discovery component examines the temporal patterns of each entity's metric data, and estimates its likelihood of being a root cause based on the Extreme Value theory.

Lower Level:

According to the inherent structure of the data, e.g., pod distribution among servers, entities in the lower level are divided into different groups. Then, the causal graph for each group is constructed via GNN-based causal graph learning method. This greatly reduces the number of causal relations compared with learning all lower-level entities simultaneously and speeds up the learning process.

Between Levels:

During between-level learning, the output embeddings of GNNs from the previous level are aggregated according to the causal relations between related entities or between entities and system performance in adjacent levels. The lower-level influences propagate through the between-level aggregation.

Higher Level:

Besides original input features, aggregated embeddings from between-level learning are added to form the augmented input features. The resulting causal graph in the higher level is more robust and more consistent by taking the lower-level influence into consideration.

System Level:

As the last level of the framework, the system level incorporates all influences from previous levels by traversing through casual graphs in each level and between levels. Moreover, by backpropagating the prediction error of the system KPI, the parameters in previous levels including causal graph parameters and regression parameters are updated simultaneously, enabling a more robust and more consistent causal graph learning.

This framework is not limited to a 3-level configuration, and it can be applied to datasets with deeper structures.

It is to be understood that aspects of the present invention will be described in terms of a given illustrative architecture; however, other architectures, structures, components, and process features and steps can be varied within the scope of aspects of the present invention.

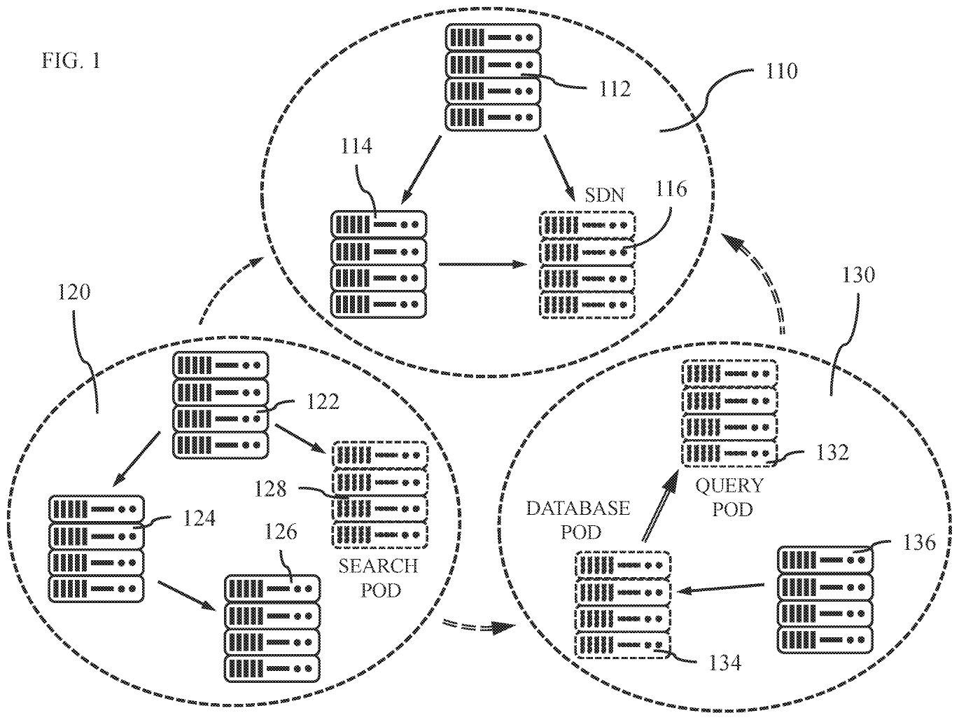

Referring now in detail to the figures in which like numerals represent the same or similar elements and initially to FIG. 1, FIG. 1 shows a cascading failure between interacting systems in interdependent causal networks that would generate a root cause analysis, in accordance with an embodiment of the present invention.

In various embodiments, a complex system can include

A main network, including a server/machine network, is represented by dashed nodes (ellipses) 110, 120, 130 and edges (curved arrows), where the dashed network is the main network, G, having three server nodes. Domain-specific networks, including application/pod networks, are represented by solid nodes (server icons) 112, 114, 116, 122, 124, 126, 128, 132, 134, 136 and edges (straight arrows). Each of the main nodes can include a domain-specific network that is made up of several applications/pods (solid icons). In FIG. 1, the malfunctioning effects of a propagating root cause malfunction are indicated by double lined (solid or dashed) arrows to show how the failure propagates through a multi-level system. The fuzzy/blurred server icons 128, 134, 132, 116 indicate the malfunctioning components of the complex system with the origin/root cause of the failure at the Search Pod 128.

As illustrated in FIG. 1, a dashed network represents a server/machine network (the main network), where the nodes 110, 120, 130 represent three different servers, and edges/links indicate the causal relations among the different servers. Each node 110, 120, 130 of this main network is further represented as a pod network (the domain-specific network), where pod nodes 112, 114, 116, 122, 124, 126, 128, 132, 134, 136 are pods and edges denote their causal relations, as a (server-pod) interdependent network. Because the edges in this interdependent network structure indicate causal dependencies, this can be referred to as interdependent causal networks.

For example, the malfunction of a “search” pod 128 in a first pod network 120 can spread to a server network and cause a fault in a server, then spread to a second pod network 130 and cause faults in a “database” pod 134 and a “query” pod 132. Finally, a Software-defined networking (SDN) pod 116 can be affected resulting in the system failure. Other pods can also be affected with a system failure resulting. If only the server network (i.e., the three servers) or one of the three pod networks of the microservice system was modeled, it could be very hard to pinpoint the root cause originating at the “search” pod 128.

In one or more embodiment, the interconnected multi-network structures can be modeled to provide a comprehensive understanding of the system and a more effective root cause analysis. This can be accomplished through a network-of-network model, where each node of a main network, G, can be represented as another network. A neural network can learn interdependent causal relations between different levels of system entities and the system KPI. There can be more than one entity metric (i.e., multi-variate time series) per system entity.

In various embodiments, interdependent causal networks can be learned and fault propagation in interdependent causal networks can be modeled. To capture propagation patterns for root cause localization, the causal relationships not only within the same level but also across levels can be learned.

In various embodiments, temporal patterns from the metrics data of each individual system entity can be captured. In addition to the topological patterns, the features of metrics data, which can be time series, associated with the system entities can also exhibit abnormal patterns from a temporal perspective during the incidence of system faults. The metrics of root causes may fluctuate more strongly than those of other entities; thus, the temporal patterns from the metrics of each system entity can provide individual causal insights for locating root causes.

In one or more embodiments, a generic interdependent causal networks based framework for root cause localization can include Topological Causal Discovery (TCD) and Individual Causal Discovery (ICD). A hierarchical graph neural networks based causal discovery method can discover both intra-level (i.e., within-network) and inter-level (i.e., across-network) nonlinear causal relationships. The ICD component can focus on individual causal effects, by analyzing the metrics data (i.e., time series) of each system entity. An Extreme Value theory based method can capture the temporal fluctuation patterns and estimate the likelihood of each entity to be a root cause. In various embodiments, the findings of the individual and topological causal discovery can be combined.

Given a g×g main network G, where g is the number of nodes in a 2-dimensional arrangement, a set of domain specific networks A={A₁, . . . , A_{g}}, and a one-to-one mapping function θ that maps each node, g, in G to a domain specific network, a NoN can be defined as a triplet R=<G, A, θ>. The node set in G, which can be referred to as high-level nodes, can be denoted as VG, and the node set in A, which can be referred to as low-level nodes, can be denoted as V^{A}=(V^{A}^{¹}, . . . , V^{Ag}). Given measurement time-series of hierarchical system components corresponding to high-level and low-level nodes in main and domain specific networks {X^{G}, X^{A}}, and system status indicator, y, an interdependent causal network, R=<G, A, θ>, may be constructed, and identify the top K low-level nodes in V^{A} that are most relevant to y.

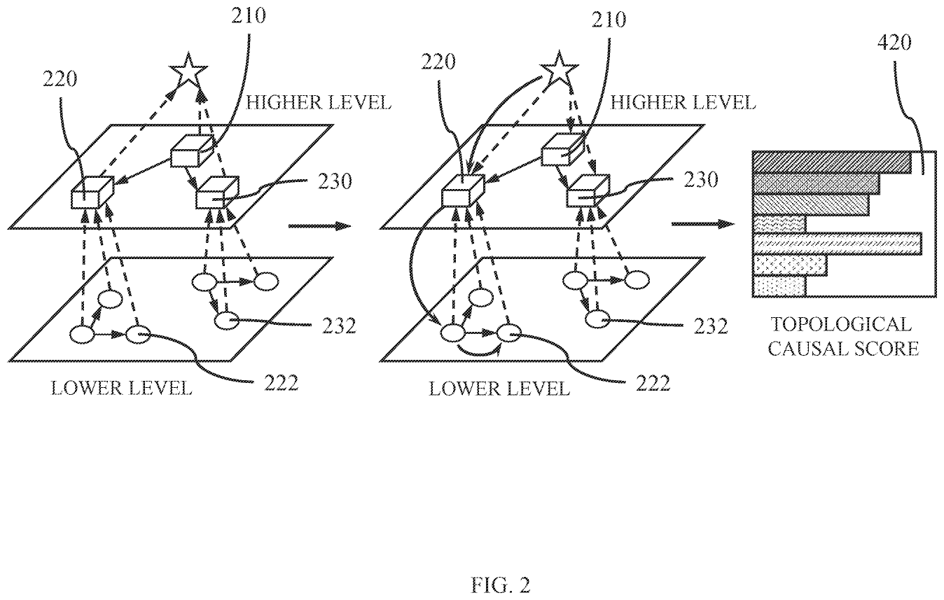

FIG. 2 is a block/flow diagram illustrating a system/method for a neural network framework for topological causal discovery, in accordance with an embodiment of the present invention.

This process outputs the topological causal score 420 of each low-level node 222, 232 and each high-level node 210, 220, 230, indicating which nodes are likely to be root causes and which nodes are affected more significantly by the failure/fault events.

In various embodiments, there can be more than one entity metric (i.e., multi-variate time series) per system entity. For each individual metric, an interdependent causal graph among different system entities can be learned by the neural network using the same learning strategy.

In various embodiments, the metric of system entities (e.g., high-level or low-level) can be a multivariant time series {x₀, . . . , x_{T}}. The metric value at the t-th time step is xₜ∈R^{d}, where d is the number of entities (i.e., pods or nodes).

In various embodiments, the data can be modeled using the VAR model whose formulation is given by:

x^{T}t=x^{T}ₜ₋₁B₁+ . . . +x^{T}ₜ₋ₚBₚ+ϵ^{T}ₜ,t={p, . . . ,T};

where p is the time-lagged order, ϵ^{T} is the vector of error variables that are expected to be non-Gaussian and independent in the temporal dimension, {B₁, . . . , Bₚ} are the weighted matrix of time-lagged data. In the VAR model, the time series, xₜ, at t, is assumed to be a linear combination of the past p lags of the series.

Assuming that {B₁, . . . , Bₚ} is constant across time, the above Equation can be extended into a matrix form:

X=\tilde{X}₁B₁+ . . . +\tilde{X}ₚBₚ+ε;

where X∈ [symbol] ^{m×d} is a matrix and its each row is xₜ^{T}; {\tilde{X}₁, . . . , \tilde{X}ₚ} are the time-lagged data.

To simplify, let \tilde{X}=|\tilde{X}₁| . . . |\tilde{X}ₚ| with its shape of X∈ [symbol] ^{m×pd},

and B=|B₁| . . . |Bₚ| with its shape of X∈ [symbol] ^{m×pd},

Here, m=T+1−p is the effective sample size, because the first p elements in the metric data have no sufficient time lagged data to calculate X=\tilde{X}₁B₁+ . . . +\tilde{X}ₚ Bₚ+ε. After that, QR decomposition can be applied to the weight matrix B to transform X=\tilde{X}₁B₁+ . . . +\tilde{X}ₚ Bₚ+ε as follows:

X=\tilde{X}\hat{B}W+ε;

where \hat{B}∈ [symbol] ^{m×pd} is the weight matrix of time-lagged data in the temporal dimension; W∈ [symbol] ^{m×pd} is the weighted adjacency matrix, which reflects the relations among system entities.

A nonlinear autoregressive model allows xₜ to evolve according to more general nonlinear dynamics. In a forecasting setting, one promising way is to jointly model the nonlinear functions using neural networks. By applying neural networks f to X=\tilde{X}\hat{B}W+ε; we have:

X=f(\tilde{X}\hat{B}W;Θ)+ε;

where Θ is the set of parameters off.

Given the data X and \tilde{X}, here weighted adjacency matrices W that correspond to directed acyclic graphs (DAGs) can be estimated. The causal edges in W may go only forward in time, and thus they do not create cycles. In order to ensure that the whole network is acyclic, it thus suffices to require that W is acyclic. Minimizing the least-squares loss with the acyclicity constraint gives the following optimization problem:

$$min \frac{1}{m} {‖ X = f ( \tilde{X} \hat{B} W ; Θ ) ‖}^{2} ;$$

such that W is acyclic.

To learn W in an adaptive manner, we adopt the following layer to update W:

W=RELU(tan h(W₊W₋^{T}−W₋W₊^{T}));

where W₊∈ [symbol] ^{d×d} and W₋∈ [symbol] ^{d×d} are two parameter matrices. This learning layer aims to enforce the asymmetry of W, because the propagation of malfunctioning effects is unidirectional and acyclic from root causes to subsequent entities.

In the following sections, W^{G} denotes the causal relations between high-level nodes and W^{A} denotes the causal relations between low-level nodes. Data can be with hierarchical structures in real complex systems.

Then, the causal structure learning process for the interdependent networks can be divided into intra-level learning and inter-level learning. Intra-level learning is to learn the causal relations among the same level of nodes, while interlevel learning is to learn the cross-level causal relations. To model the influence of low-level nodes on high-level nodes, low-level information can be aggregated into high-level nodes in inter-level learning.

For the learning process of hierarchical GNNs, the Intra-level learning captures causal relations within the same-level system entities. Inter-level learning aggregates low-level information to high-level for constructing cross-level causal relations.

For intra-level learning, the same learning strategy can be adopted to learn causal relations among both high-level nodes and low-level nodes. Specifically, the L layers of GNN can be applied to the time-lagged data {xₜ₋₁, . . . , xₜ₋ₚ}∈R^{d×p} to obtain its embedding. In the l-th layer, the embedding z^{(l)} is obtained by aggregating the nodes' embedding and their neighbors' information at the l−1 layer. Then, the embedding at the last layer z(L) is used to predict the metric value at the time step t by a MLP layer. This process can be represented as:

$$\{ \begin{matrix}{z}^{( 0 )} = [ {x}_{t - 1} , … , {x}_{t - p} ] , \\ {z}^{( l )} = GNN ( Cat ( {z}^{( l - 1 )} , W \cdot {z}^{( l - 1 )} ) \cdot {B}^{( l )} ) , \\ {{x}^{⌣}}_{t} = MLP ( {z}^{( L )} ; Θ ) ,\end{matrix}$$

where Cat is the concatenation operation; B^{(l)} is the weight matrix of the l-th layer; GNN is activated by the RELU function to capture non-linear correlations in the time-lagged data. This can minimize the difference between the actual value xₜ and the predicted value, \check{x}ₜ.

Thus, the optimization objective is defined as follows:

$$ℒ = \frac{1}{m} {\sum }_{t} {( {x}_{t} - {{x}^{⌣}}_{t} )}^{2} .$$

The intra-level learning can be conducted for the low-level and high-level system entities for constructing W^{A} and W^{G}, respectively. The optimization objectives for the low-level and high-level causal relations can be denoted by [symbol] _{A} and [symbol] _{G}, respectively.

For inter-level learning, the information of low-level nodes to the high-level nodes can be aggregated for constructing the cross-level causal relations. So, the initial embedding of high-level nodes, \ddot{z}⁽⁰⁾, is the concatenation of their time-lagged data {\ddot{x}ₜ₋₁, . . . , xₜ₋ₚ} and aggregated low-level embeddings, which can be formulated as follows:

\ddot{z}⁽⁰⁾=Cat([\ddot{x}ₜ₋₁, . . . ,\ddot{x}ₜ₋ₚ],\ddot{W}·z^{(L)});

where \ddot{W} is a weight matrix that controls the contributions of low-level embeddings to high-level embeddings. There can be two inter-level learning parts. The first one can be used to learn the cross-level causal relations between low-level and high-level nodes, denoted by \ddot{W}^{AG}. The second one can be used to construct the causal linkages between high level nodes and the system KPI, denoted by \ddot{W}^{GS}. During this process, the value of the system KPI can be predicted at the time step, t, where the predicted values can be made as close to the actual ones. Hence, the optimization objective, [symbol] _{S}, can also be formulated as:

$${ℒ}_{S} = \frac{1}{m} {\sum }_{t} {( {x}_{t} - {{x}^{⌣}}_{t} )}^{2} ;$$

In addition, the learned interdependent causal graphs must meet the acyclicity requirement. But since the cross-level causal relations \ddot{W}^{AG} and \ddot{W}^{GS} are unidirectional, only W^{A} and W^{G} need to be acyclic. To achieve this goal, inspired by the work, we use the trace exponential function:

h(W)=tr(e^{wºw})−d=0,

that satisfies h(W)=0 if and only if W is acyclic. Here, º is the Hadamard product of two matrices. Meanwhile, to enforce the sparsity of W^{A} and W^{G}, \ddot{W}^{AG} and \ddot{W}^{GS} for producing robust causal relations, we use the L1-norm to regularize them. So, the final optimization objective is:

$${ℒ}_{final} = ( {ℒ}_{A} + {ℒ}_{G} + {ℒ}_{S} )$$

$$+ {λ}_{1} ( {‖ {W}^{A} ‖}_{1} + {‖ {W}^{G} ‖}_{1} + {‖ {\ddot{W}}^{AG} ‖}_{1} + {‖ {\ddot{W}}^{GS} ‖}_{1} )$$

$$+ {λ}_{2} ( h ( {W}^{A} ) + h ( {W}^{G} ) )$$

where ∥·∥₁ is the element-wise L1-norm; λ₁ and λ₂ are two parameters that control the contribution of regularization items. We aim to minimize L_{final} through the L-BFGS-B solver. When the model converges, we construct interdependent causal networks through W^{A}, W^{G}, \ddot{W}^{AG} and \ddot{W}^{GS}.

For Network Propagation on Interdependent Causal Graphs, learning interdependent causal structures is not sufficient for root cause localization tasks. As aforementioned, starting from the root cause entity, malfunctioning effects will propagate to neighboring entities, and different types of system faults can trigger diverse propagation patterns.

This observation motivates us to apply network propagation to the learned interdependent causal structure to mine the hidden actual root causes.

The learned interdependent causal structure is a directed acyclic graph, which reflects the causal relations from the low level to the high-level to the system level. In order to trace back the root causes, we need to conduct a reverse analysis process. Thus, we transpose the learned causal structure to get:

<<G^{T},A^{T},E″>,KPI>1,

then apply a random walk with restart on the interdependent causal networks to estimate the topological causal score of each node.

Specifically, we first define the adjacency matrix of the transposed result as:

$$[ \begin{matrix}{G}^{⊤} & \ddot{W} \\ {\ddot{W}}^{⊤} & {𝒜}^{⊤}\end{matrix} ] ;$$

Then, we calculate the transition probabilities of a particle on the interdependent networks, denoted by:

$$H = [ \begin{matrix}{H}_{GG} & {H}_{G 𝒜} \\ {H}_{𝒜 G} & {H}_{𝒜𝒜}\end{matrix} ]$$

where H_{GG} and H_{AA} depict the walks within the same-level network. H_{GA} and HAG describe the walks across different level networks.

Imagine that from the KPI node, a particle begins to visit the networks. The particle randomly selects a high-level or low-level node to visit, then the particle either jumps to the low-level nodes or walks in the current graph with a probability value Φ∈[0, 1]. The higher the value of Φ is, the more possible the jumping behavior occurs. In detail, if a particle is located at a high-level node i in G, the probability of the particle moving to the high-level node j is:

H_{GG}(i,j)=(1−Φ)G^{T}(i,j)/Σₖ₌₁^{g}G^{T}(i,k);

or jumping to the low-level node b with a probability:

[symbol]

(i,b)=Φ\ddot{W}(i,b)/Σₖ₌₁^{gd}\ddot{W}(i,k);

We apply the same strategy when the particle is located at a low-level node. The visiting probability of the particle walking from a low-level node i to another low-level node j is:

[symbol]

(i,j)=(1−Φ) [symbol] (i,j)/Σₖ₌₁^{g} [symbol] ^{T}(i,k)

The particle can also move to the high-level node b with a probability

[symbol]

(i,b)=Φ\ddot{W}(i,b)/Σₖ₌₁^{g}\ddot{W}(i,k);

The probability transition evolving equation of the random walk with restart can be formulated as:

\tilde{p}ₜ₊₁^{T}=(1−φ)H\tilde{p}ₜ^{T}+φ\tilde{p}ₜᵣₛ^{T};

where \tilde{p}ₜ₊₁^{T}∈ [symbol] ^{g+gd} and \tilde{p}ₜ^{T} ∈ [symbol] ^{g+gd} are the visiting probability distribution at different time steps;

\tilde{p}ᵣₛ^{T}∈ [symbol] ^{g+gd},

is the initial visiting probability distribution that depicts the visiting possibility of high-level or low-level nodes at the initialization step. φ∈[0, 1] is the restart probability. When the visiting probability distribution is convergence, we regard the probability score of the low-level nodes as the associated topological causal score.

Here, Ë contains not only the edges between the nodes in [symbol] and the nodes in G but also the edges between the nodes in G and the node of system KPI.

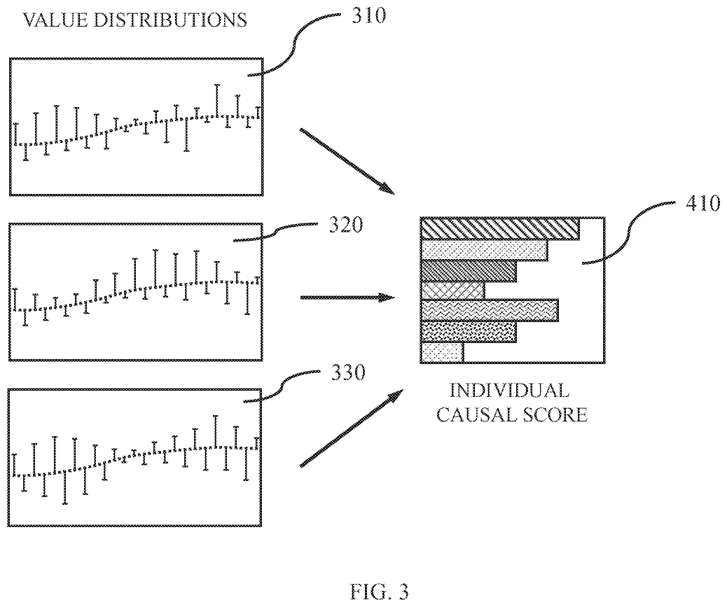

FIG. 3 is a flow diagram illustrating a system/method for an extreme value theory framework for individual causal discovery, in accordance with an embodiment of the present invention, in accordance with an embodiment of the present invention.

Individual Root Cause Discovery:

In addition to the topological causal effects, the entity metrics 310, 320, 330 of root causes themselves could fluctuate stronger than those of other system entities during the incidence of system faults. Thus, we propose to individually analyze the temporal patterns in the metrics data of each system entity, which provides individual causal guidance for locating root causes.

Comparing with the values of entity metrics in normal time, the fluctuating values are extreme and infrequent. Such extreme values follow the extreme value distribution, which is defined as:

$${U}_{ζ} : x \to exp ( - {( 1 + ζ x )}^{- \frac{1}{ζ}} ) , ζ ∈ ℝ , 1 + ζ x > 0.$$

where x is the original value and ζ is the extreme value index depending on the distribution of x. Let the probability of potential extreme value in x be q, the boundary2 ζ of normal value can be calculated through P(X>ζ)=q based on Uζ. However, since the distribution of x is unknown, should be estimated. The Pickands-Belkema-de Haan theorem provides an approach to estimate ζ.

The extrema of a cumulative distribution F converge to the distribution of U_{ζ}, denoted as F∈D_{ζ}, if and only if a function δ exists, for all x∈R s.t. 1+ζx>0:

$$\begin{matrix}\frac{\overline{F} ( η + δ ( η ) x )}{\overline{F} ( η )} & {η \to τ}^{⟶} & {( 1 + ζ x )}^{- \frac{1}{ζ}}\end{matrix} .$$

where η is a threshold for peak normal value and τ is the bound of the initial distribution, so it can be finite or infinite.

This theorem can be rewritten as:

$${\overline{F}}_{ζ} ( x ) = ℙ ( X - η > x \vert X > η ) \sim {( 1 + \frac{ζ x}{δ ( η )} )}^{- \frac{1}{ζ}} .$$

This result shows that X−η follows a Generalized Pareto Distribution (GPD) with parameters ζ and δ. We can utilize the maximum likelihood estimation method to estimate ζ and δ. Then, the boundary of normal value can be calculated by:

$$ϱ ≃ η + \frac{δ}{ζ} ( {( \frac{qn}{{N}_{η}} )}^{- ζ} - 1 ) .$$

where η, q can be provided by domain knowledge, n is the total number of observations, Nη is the number of peak values (i.e., the number of X>η).

Our method of individual root causal discovery is devised based on the Equation below. Specifically, let time series {x₀, x₁, . . . , x_{T}} be the metric values of one system entity (high-level or low-level). It is divided into two segments. The first segment is used for initialization and the second one is used for detection. For initialization, we first provide the probability of extreme value q and the threshold of peak value η based on the requirements. Then, we use the first-time segment to estimate the boundary ζ of normal value according to:

$$ϱ ≃ η + \frac{δ}{ζ} ( {( \frac{qn}{{N}_{η}} )}^{- ζ} - 1 ) .$$

Here, η should be lower than ζ. For detection, we compare each value in the second time segment with ζ and η. If the value is larger than ζ, the value is abnormal, so we store it. If the value is less than ζ but larger than η, which means the boundary ζ has been changed. Hence, we add it to the first segment and re-evaluate the parameters ζ and δ for getting a new boundary of normal values. If the value is less than η, it is normal, so we ignore it. Finally, we can collect all abnormal values in the entity metric. To provide objective and unified evaluation criteria, we normalize these abnormal values using the Sigmoid function and use the mean of the normalized values as the individual causal score 410 of the associated system entity.

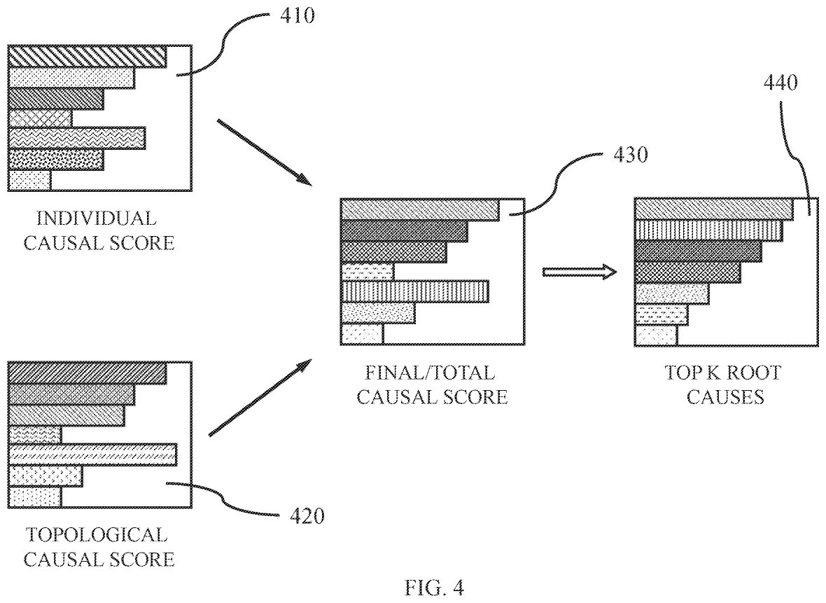

FIG. 4 is a flow diagram illustrating a system/method for an interdependent causal network framework for causal integration, in accordance with an embodiment of the present invention.

Causal Integration:

In our setting, we aim to find the fine-grained root causes. Hence, the causal discovery results of low-level nodes are integrated. Through the previous two steps, we have obtained the individual causal scores 410 and topological causal scores 420 of low-level system entities. Then, we integrate the two results through the integration parameter 0≤y≤1, to produce a final/total causal score 430 which can be represented as:

q_{final}=γq_{indiv}+(1−γ)qₜₒₚₒₗ.

After that, we rank low-level nodes using q_{final} and select the top K results 440 as the final root causes of system faults.

To encode the non-linear intra-level and inter-level causal relationships, hierarchical graph neural networks were used to learn the representations of system entities via the message passing mechanism.

Integrating individual and topological causal discovery results can sufficiently capture the temporal and propagation patterns of malfunctioning effects for precisely locating root causes. It may be seen that the propagation of malfunctioning effects is more important than the temporal patterns for localizing root causes. In conclusion, the experimental findings illustrate that individual and topological causal discovery components can capture distinct patterns of malfunctioning effects.

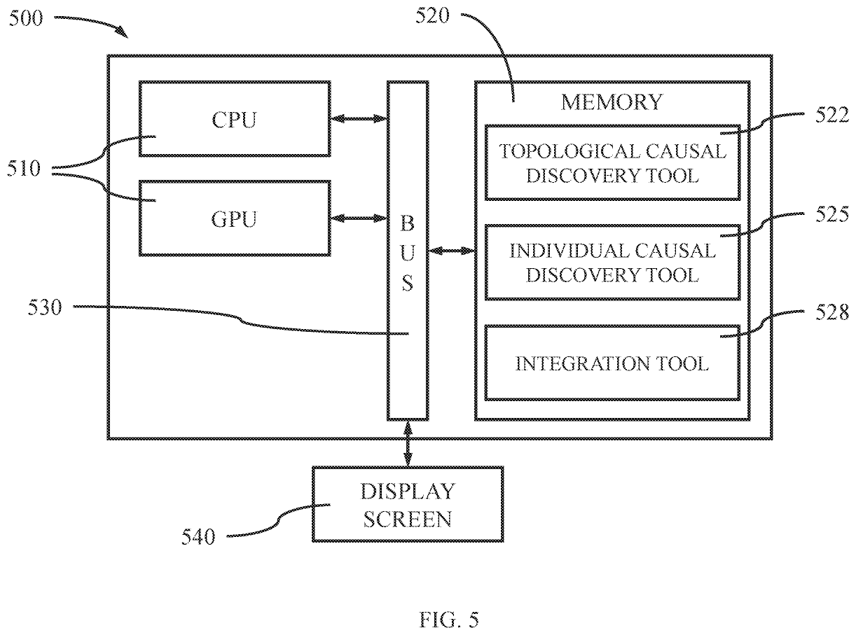

FIG. 5 is a block diagram illustrating a system for a neural network framework for topological causal discovery and individual causal discovery, in accordance with an embodiment of the present invention.

In one or more embodiments, a system 500 for a neural network framework for topological causal discovery and individual causal discovery can include one or more processors 510, for example, central processing units (CPUs), graphics processing units (GPUs), and combinations thereof, electrically coupled to a memory 520, for example, hard disk drives (HDDs), solid state drives (SSDs), random access memory (RAM), and combinations thereof, through a bus 530. In various embodiments, the system 500 can be configured to perform Root Cause Analysis (RCA) to identify the root causes of system faults using surveillance metrics data. The output of the system 500 can be presented to a user on a display screen 540 electrically coupled to the system bus 530.

In one or more embodiments, the system 500 for the neural network framework for topological causal discovery and individual causal discovery can include a topological causal discovery tool 522, an individual causal discovery tool 525 stored in the memory 520, and an integration tool 528. The system can be configured to perform the features described in the application and FIGS. 1-4.

In one or more embodiments, the system 500 for the neural network framework for topological causal discovery and individual causal discovery can include a topological causal discovery tool 522 stored in the memory 520, where the topological causal discovery tool 522 is trained and configured to automatically assessed causal links between monitoring system metrics and system KPI using the framework. The topological causal discovery tool 522 can be configured to receive Key Performance Indicators (KPIs), and can analyze interdependent causal networks. The topological causal discovery tool 522 can be trained to model the interdependent causal relationships, and the propagation of malfunctioning effects in learned causal interdependent networks. This can be an hierarchical graph neural networks based system/method.

The system 500 can be configured to discover both intra-level (i.e., within-network) and inter-level (i.e., across-network) nonlinear causal relationships. In various embodiments, the topological causal discovery tool 522 can perform a random walk with restarts to model the network propagation of a system fault in interdependent causal networks.

In one or more embodiments, the system 500 for the neural network framework for topological causal discovery and individual causal discovery can include an individual causal discovery tool 525 stored in the memory 520, where the individual causal discovery tool 522 is trained and configured to automatically assessed causal links between monitoring system metrics and system KPI using the framework.

The individual causal discovery tool 525 can be configured to receive metrics data of individual system entity, and can analyze interdependent causal networks. The individual causal discovery tool 525 can be configured to monitor time series that indicates a system's status. The individual causal discovery tool 525 can be trained to model the interdependent causal relationships, and the propagation of malfunctioning effects in learned causal interdependent networks based on capture temporal patterns from the metrics data (e.g., time series) of individual system entities. The individual causal discovery tool 525 can be trained to detect abnormal patterns from temporal perspective during the incidence of system faults to locate root causes, where an Extreme Value theory based method can capture the temporal fluctuation patterns and estimate the likelihood of each entity to be a root cause.

In one or more embodiments, the system 500 for the neural network framework for topological causal discovery and individual causal discovery can include an integration tool 528 stored in the memory 520, where the integration tool 528 is trained and configured to combine 430 the findings of the individual and topological causal discovery (i.e., causal integration), and output the identities of the system entities 440 with the top-K greatest causal scores as the root causes. In various embodiments, the findings of the individual and topological causal discovery, and the identities of the system entities with the top-K greatest causal scores can be presented to a user on a display screen 540. The identified root causes can be low-level system entities to reflect fine-grained root cause detection of multi-level system entities corresponding to high-level and low-level nodes in main and domain-specific networks.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for training a hierarchical graph neural network, comprising:
using a time series generated by each of a plurality of nodes to train a graph neural network to generate a causal graph;
identifying interdependent causal networks that depict hierarchical causal links from low-level nodes to high-level nodes to the system key performance indicator (KPI);
simulating causal relations between entities by aggregating embeddings from neighbors in each layer; and
generating output embeddings for entity metrics prediction and between-level aggregation.

2. The method as recited in claim 1, wherein the entity metrics data includes CPU utilization, memory usage, system key performance indicator (KPI) data, and combinations thereof.

3. The method as recited in claim 2, wherein the key performance indicator (KPI) is a latency time, a connection time, or a combinations thereof.

4. The method as recited in claim 3, further comprising collecting the time series from each of the nodes by monitoring system components of each node.

5. The method as recited in claim 4, wherein the causal structure learning process for the interdependent networks is divided into intra-level learning and inter-level learning.

6. The method as recited in claim 5, wherein the information of low-level nodes to the high-level nodes is aggregated for constructing a cross-level causal relations, so the initial embedding of high level nodes, \ddot{z}⁽⁰⁾, is the concatenation of their time-lagged data {\ddot{x}ₜ₋₁, . . . , xₜ₋ₚ} and aggregated low-level embeddings, which can be formulated as \ddot{z}⁽⁰⁾=Cat([\ddot{x}ₜ₋₁, . . . , xₜ₋ₚ])\ddot{W}·z^{(L)}); where \ddot{W} is a weight matrix that controls the contributions of low-level embeddings to high-level embeddings.

7. The method as recited in claim 6, wherein learned interdependent causal graphs meet an acyclicity requirement.

8. The method as recited in claim 7, wherein a random walk with restart on interdependent causal networks is used to estimate the topological causal score of each node.

9. The method as recited in claim 8, wherein transition probabilities of a particle on the interdependent networks is calculated as:
$$H = [ \begin{matrix}{H}_{GG} & {H}_{G 𝒜} \\ {H}_{𝒜 G} & {H}_{𝒜𝒜}\end{matrix} ]$$
where H_{GG} and H_{AA} depict the walks within the same-level network, and H_{GA} and H_{AG} describe the walks across different level networks.

10. A method for identifying most probable root causes, comprising:
detecting a system failure;
conducting topological cause learning by extracting causal relations from entity metrics data and system key performance indicator (KPI) data;
propagating the system failure over a learned causal graph;
generating a topological cause score representing how much a component can be the root cause;
generating an individual cause score based on entity metrics using extreme value theory;
detecting anomalous entities based on performance of individual components;
aggregating the topological cause score and individual cause score to obtain a root cause ranking to discover the most probable root causes; and
identifying a top K system entities associated with the most probable root causes.

11. The method as recited in claim 10, wherein individual causes of the entity metrics are detected based on an extreme value theory.

12. The method as recited in claim 11, wherein abnormal values of the entity metrics are normalized using a Sigmoid function, and a mean value of the normalized values are used as the individual causal score of the associated system entity

13. The method as recited in claim 12, wherein identifying most probable root causes does not require any domain/prior knowledge as input for root cause localization.

14. A system for identifying most probable root causes, comprising:
one or more processors;
a display screen coupled to the one or more processors through a bus;
memory coupled to the one or more processors through the bus, wherein the memory includes a topological causal discover tool configured to system key performance indicator (KPI), detect a system failure, conducting topological cause learning by extracting causal relations from entity metrics data and system key performance indicator (KPI) data, propagate the system failure over a learned causal graph, and generate a topological cause score representing how much a component can be the root cause;
an individual causal discovery tool configured to receive entity metrics, generate an individual cause score based on the entity metrics using extreme value theory, and detect anomalous entities based on performance of individual components; and
an integration tool configured to aggregate the topological causal score and the individual causal score to obtain a root cause ranking to discover the most probable root causes, identify a top K system entities associated with the most probable root causes, wherein identifying most probable root causes does not require any domain/prior knowledge as input for root cause localization, and display the most probable root causes to a user on the display screen.

15. The system as recited in claim 14, wherein a random walk with restart on interdependent causal networks is used to estimate the topological causal score of each node.

16. The system as recited in claim 15, wherein information of low-level nodes to the high-level nodes is aggregated for constructing a cross-level causal relations, so the initial embedding of high level nodes, \ddot{z}⁽⁰⁾, is a concatenation of their time-lagged data {\ddot{x}ₜ₋₁, . . . , xₜ₋ₚ} and aggregated low-level embeddings, which can be formulated as \ddot{z}⁽⁰⁾=Cat([\ddot{x}ₜ₋₁, . . . , xₜ₋ₚ],\ddot{W}·z^{(L)}); where \ddot{W} is a weight matrix that controls the contributions of low-level embeddings to high-level embeddings.
